(19) United States
(12) Patent Application Publication
(10) Pub. No.: US 2026/0203066 A1
(43) Pub. Date: Jul. 16, 2026

(54) DEVICE AND METHOD WITH INSTRUCTION-BASED COMPUTING

(71) Applicant: Samsung Electronics Co., Ltd., Suwon-si (KR)

(72) Inventors: Jangho AN, Suwon-si (KR); Soonwan KWON, Suwon-si (KR)

(73) Assignee: Samsung Electronics Co., Ltd., Suwon-si (KR)

(21) Appl. No.: 19/303,683

(22) Filed: Aug. 19, 2025

(30) Foreign Application Priority Data
Jan. 13, 2025 (KR) 10-2025-0005049

(51) Int. Cl. G06F 9/30; G06F 9/38

(52) U.S. Cl. CPC G06F 9/30185; G06F 9/3001; G06F 9/30079; G06F 9/3814

(57) ABSTRACT

A computing device includes a memory configured to store input data and a plurality of instructions, a processor configured to execute instructions of a predetermined length among the plurality of instructions received from the memory, a command queue configured to receive, from the processor, instructions corresponding to an accelerator among the instructions of the predetermined length and generate a merged instruction by merging the received instructions through an arithmetic logic unit (ALU), and the accelerator configured to perform an operation between the input data and pre-stored data in response to receiving the merged instruction from the command queue.

### CROSS-REFERENCE TO RELATED APPLICATIONS

This application claims the benefit under 35 USC § 119(a) of Korean Patent Application No. 10-2025-0005049, filed on January 13, 2025 in the Korean Intellectual Property Office, the entire disclosure of which is incorporated herein by reference for all purposes.

### BACKGROUND

### 1. Field

The following description relates to a device and method with instruction-based computing.

### 2. Description of Related Art

Operations corresponding to a neural network model may be mainly performed by a processor and an accelerator. The neural network model may include multiple layers. For example, each layer may generate an output value through an operation using input data and a weight. During this operation process, the processor may control and manage operations to be performed in each layer. The accelerator may be used to perform an operation quickly. The processor may access a register to control the accelerator and may transmit a required setting value to the accelerator accordingly. However, when the processor includes a separate memory map in the register and stores separate instructions corresponding to the register in the memory to control the accelerator, the limited memory may be wasted and the operation speed may be reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a computing device includes a memory configured to store input data and a plurality of instructions, a processor configured to execute instructions of a predetermined length among the plurality of instructions received from the memory, a command queue configured to receive, from the processor, instructions corresponding to an accelerator among the instructions of the predetermined length and generate a merged instruction by merging the received instructions through an arithmetic logic unit (ALU), and the accelerator configured to perform an operation between the input data and pre-stored data in response to receiving the merged instruction from the command queue.

For the executing of the instructions of the predetermined length, the processor may be configured to based on an operation identifier corresponding to a specific bit range of the instructions of the predetermined length, classify the instructions of the predetermined length as instructions corresponding to the accelerator or instructions corresponding to the processor, and

transmit the instructions classified as the instructions corresponding to the accelerator to the command queue.

For the generating of the merged instruction, the command queue may be configured to determine a value from a first bit range of instructions corresponding to the accelerator and determine a command from a second bit range that is different from the first bit range.

For the generating of the merged instruction, the command queue may be configured to scan the received instructions corresponding to the accelerator through a window of a predetermined size and merge, based on a comparison result between the scanned instructions, the scanned instructions based on the ALU.

For the merging of the scanned instructions, the command queue may be configured to determine, for each of the scanned instructions, a value from a first bit range of the scanned instruction and determine a command from a second bit range of the scanned instruction that is different from the first bit range, and merge, based on the ALU, the value of a first instruction of the scanned instructions with the value of a second instruction of the scanned instructions in response to the command of the first instruction being same as the command of the second instruction among the scanned instructions.

For each of the scanned instructions, the value of the scanned instruction may indicate a number of repetitions of an operation according to the command of the scanned instruction, and for the merging of the value of the first instruction with the value of the second instruction, the command queue may be configured to accumulate the value of the first instruction and the value of the second instruction using the ALU.

For the generating of the merged instruction, the command queue may be configured to in response to a queue of the command queue being full, generate a stall signal that stops transmission of the instructions corresponding to the accelerator from the processor to the command queue, and transmit the generated stall signal to the processor.

The computing device may include a control circuit configured to, based on a comparison result between the instructions corresponding to the accelerator transmitted from the processor to the command queue, determine whether to transmit the merged instruction to the accelerator.

For the determining of whether to transmit the merged instruction, the control circuit may be configured to generate a first control signal in response to a command comprised in a current instruction being same as a command comprised in a previous instruction of the current instruction among the instructions corresponding to the accelerator transmitted from the processor to the command queue, and generate a second control signal that is different from the first control signal in response to the command comprised in the current instruction being different from the command comprised in the previous instruction.

The command queue may be configured to merge the instructions corresponding to the accelerator received from the processor in response to receiving the first control signal from the control circuit, and transmit the merged instruction to the accelerator in response to receiving the second control signal from the control circuit.

The accelerator may be configured to transmit a request signal that requests the command queue to provide another merged instruction in response to terminating the operation between the input data and the pre-stored data.

In one or more general aspects, a computing method includes storing input data and a plurality of instructions in a memory, executing, by a processor, instructions of a predetermined length among the plurality of instructions received from the memory, receiving, by a command queue, instructions corresponding to an accelerator among the instructions of the predetermined length from the processor and generating a merged instruction by merging the received instructions through an arithmetic logic unit (ALU), and performing an operation between the input data and pre-stored data in response to the accelerator receiving the merged instruction from the command queue.

The executing of the instructions of the predetermined length may include based on an operation identifier corresponding to a specific bit range of the instructions of the predetermined length, classifying, by the processor, the instructions of the predetermined length as instructions corresponding to the accelerator or instructions corresponding to the processor, and transmitting the instructions classified as the instructions corresponding to the accelerator to the command queue.

The generating of the merged instruction may include determining a value from a first bit range of the instructions corresponding to the accelerator and determining a command from a second bit range that is different from the first bit range.

The generating of the merged instruction may include scanning the received instructions corresponding to the accelerator through a window of a predetermined size, and merging, based on a comparison result between the scanned instructions, the scanned instructions based on the ALU.

The merging of the scanned instructions may include determining, for each of the scanned instructions, a value from a first bit range of the scanned instruction and determining a command from a second bit range of the scanned instruction that is different from the first bit range, and merging, based on the ALU, the value of a first instruction of the scanned instructions with the value of a second instruction of the scanned instructions in response to the command of the first instruction being the same as the command of the second instruction among the scanned instructions.

The generating of the merged instruction may include in response to a queue of the command queue being full, generating a stall signal that stops transmission of the instructions corresponding to the accelerator from the processor to the command queue, and transmitting the generated stall signal to the processor.

The method may include, based on a comparison result between the instructions corresponding to the accelerator transmitted from the processor to the command queue, determining, by a control circuit, whether to transmit the merged instruction from the command queue to the accelerator.

The determining of whether to transmit the merged instruction may include generating a first control signal in response to a command comprised in a current instruction being same as a command comprised in a previous instruction of the current instruction among the instructions corresponding to the accelerator transmitted from the processor to the command queue, and generating a second control signal that is different from the first control signal in response to the command comprised in the current instruction being different from the command comprised in the previous instruction.

In one or more general aspect, a computing method includes generating a merged instruction by merging, using an arithmetic logic unit (ALU), a value of a first instruction with a value of a second instruction in response to a command of the first instruction being the same as a command of the second instruction, the first instruction and the second instruction being of instructions corresponding to an accelerator, and performing, using the accelerator, an operation between input data and pre-stored data based on the merged instruction.

Other features and aspects will be apparent from the following detailed description, the drawings, and the claims.

### BRIEF DESCRIPTION OF THE DRAWINGS

FIG. 1 illustrates an example of a computing device.

FIG. 2 illustrates an example of a system on chip (SoC) structure including a computing device.

FIG. 3 illustrates an example of a method of performing an operation corresponding to an artificial intelligence (AI) model in a computing device.

FIGS. 4A and 4B illustrate examples of a method of merging instructions performed by a command queue.

FIG. 5 illustrates an example of a reduction in an operation delay time of a processor when a command queue generates a merged instruction.

FIG. 6 illustrates an example of an AI operation based on a computing device.

FIG. 7 illustrates an example of a method of performing an operation corresponding to an AI model in a computing device.

FIG. 8 illustrates an example of a method of merging instructions performed by a command queue.

FIG. 9 illustrates an example of an operation of a computing device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as "first," "second," and "third," or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as "on," "connected to," "coupled to," or "joined to" another component, element, or layer, it may be directly (e.g., in contact with the other component, element, or layer) "on," "connected to," "coupled to," or "joined to" the other component element, or layer, or there may reasonably be one or more other components elements, or layers intervening therebetween. When a component or element is described as "directly on," "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" to specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

Unless otherwise defined, all terms used herein including technical or scientific terms have the same meaning as commonly understood by one of ordinary skill in the art to which this disclosure pertains and after an understanding of the present disclosure. Terms, such as those defined in commonly used dictionaries, should be construed to have meanings matching with contextual meanings in the relevant art and the present disclosure, and are not to be construed to have an ideal or excessively formal meaning unless otherwise defined herein. The use of the term "may" herein with respect to an example or embodiment, e.g., as to what an example or embodiment may include or implement, means that at least one example or embodiment exists where such a feature is included or implemented, while all examples are not limited thereto. The use of the terms "example" or "embodiment" herein have a same meaning (e.g., the phrasing "in one example" has a same meaning as "in one embodiment," and "one or more examples" has a same meaning as "in one or more embodiments").

Hereinafter, examples are described in detail with reference to the accompanying drawings. When describing the examples with reference to the accompanying drawings, like reference numerals refer to like components, and any repeated description related thereto will be omitted.

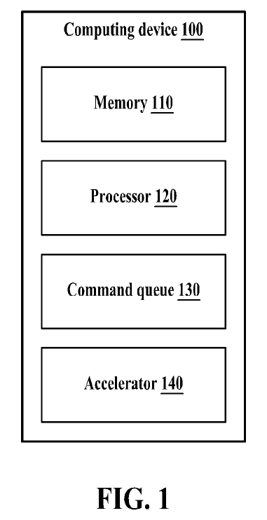

FIG. 1 illustrates an example of a computing device.

A computing device 100 of one or more embodiments may include an improved structure, may control an accelerator more effectively, and may perform optimized operations. The computing device 100 may perform an operation corresponding to an artificial intelligence (AI) model. For example, an AI model may include a plurality of layers. Various operations may be performed across the plurality of layers. The computing device 100 may perform operations respectively corresponding to the plurality of layers included in the AI model. The computing device 100 may perform a first operation (e.g., a convolution operation) based on a first layer among the plurality of layers and a second operation (e.g., a matrix multiplication operation) based on a second layer. The computing device 100 may perform at least one of a multiply-accumulate (MAC) operation, a matrix multiplication operation, a vector operation, and/or a convolution operation as an operation based on the layers of the AI model. However, the types of operations that may be performed by the computing device 100 are not limited thereto.

Among the operations corresponding to the AI model, the computing device 100 may perform one or more operations on a processor 120 (e.g., one or more processors) and one or more other operations on an accelerator 140 (e.g., one or more accelerators). A typical computing device may decrease the operation speed and efficiency by performing an operation corresponding to the AI model using only a processor and not an accelerator. In contrast, the computing device 100 of one or more embodiments may increase the operation speed and efficiency by performing operations supported by the accelerator 140 among the operations corresponding to the AI model through the accelerator 140. The computing device 100 may distinguish between an instruction for an operation performed by the processor 120 and an instruction for an operation performed by the accelerator 140. The computing device 100 of one or more embodiments may efficiently perform operations based on the AI model simultaneously and/or in parallel by distributing instructions to the processor 120 and the accelerator 140.

The computing device 100 may include a memory 110 (e.g., one or more memories), the processor 120, a command queue 130, and the accelerator 140.

The memory 110 may store input data and a plurality of instructions. For example, the input data may be scalar data, vector data, matrix data, and/or tensor data. The plurality of instructions may include instructions corresponding to the processor 120 and instructions corresponding to the accelerator 140. For example, the memory 110 may be or include a non-transitory computer-readable storage medium storing code that, when executed by the processor 120 (or the accelerator 140), configures the processor 120 (or the accelerator 140) to perform any one, any combination, or all of the operations and/or methods of a processor (or an accelerator) described herein with reference to FIGS. 1-9.

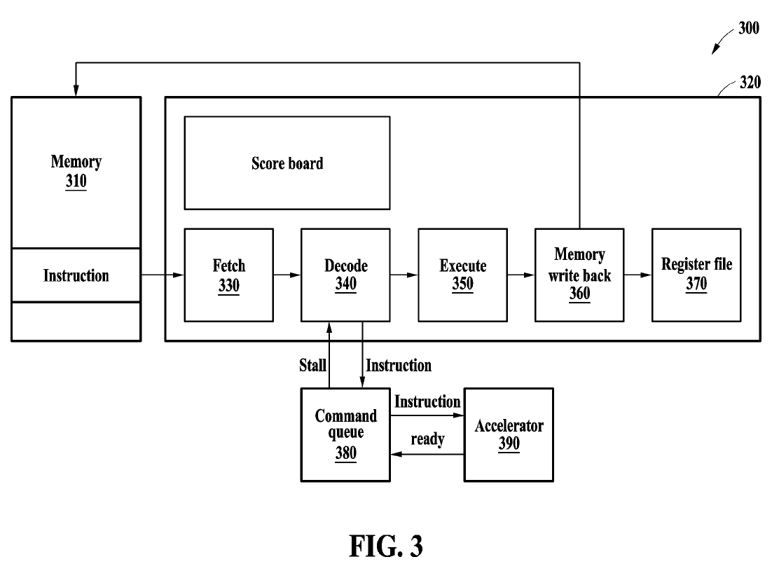

The processor 120 may receive the plurality of instructions from the memory 110. The processor 120 may execute instructions of a predetermined length among the received plurality of instructions. For example, the processor 120 may include a reduced instruction set computer-version 5 (RISC-V) central processing unit (CPU). For example, the processor 120 may execute instructions of 32-bit size. Alternatively, the processor 120 may execute instructions of 64-bit size. The instructions executed by the processor 120 may have the same size. However, the type of the processor 120 and the sizes of instructions to be executed by the processor 120 are not limited thereto. The processor 120 may classify the plurality of instructions as instructions corresponding to the processor 120 or instructions corresponding to the accelerator 140. For example, based on an operation identifier corresponding to a specific bit range of the instructions of the predetermined length, the processor 120 may classify the instructions of the predetermined length as instructions corresponding to the processor 120 or instructions corresponding to the accelerator 140. The processor 120 may transmit an instruction corresponding to the accelerator 140 among the classified instructions to the command queue 130. Additionally, the processor 120 may execute an instruction corresponding to the processor 120 among the classified instructions. Examples of the operations of the processor 120 are described below in detail with reference to FIG. 3.

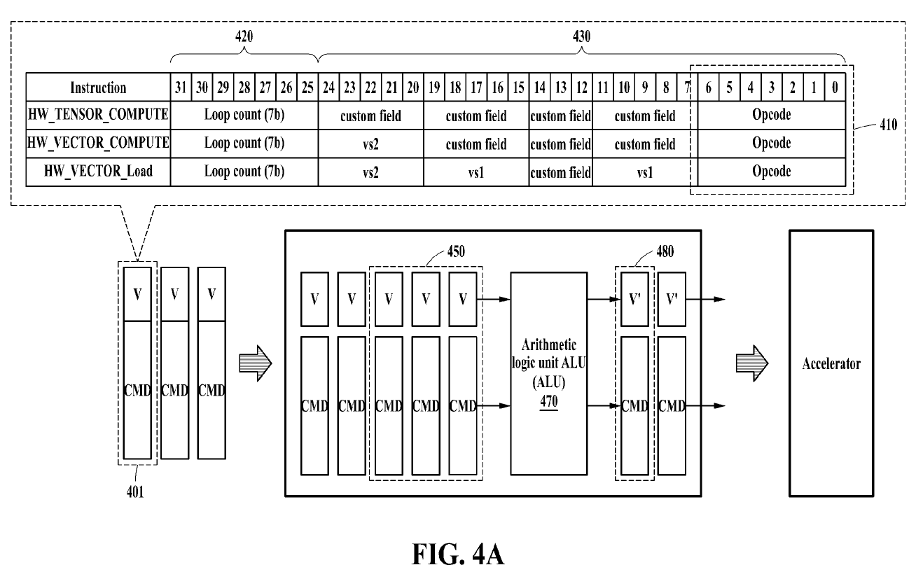

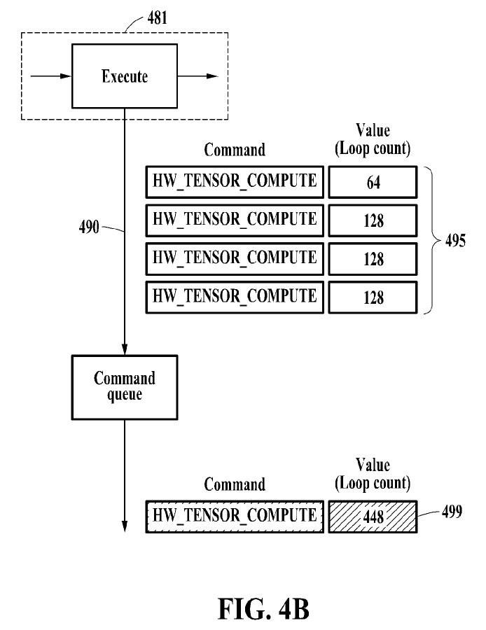

The command queue 130 may receive instructions corresponding to the accelerator 140 among the instructions of the predetermined length from the processor 120. Each instruction may have bit value(s) of a first bit range and bit value(s) of a second bit range. The second bit range may be different from the first bit range, and the second bit range and the first bit range may be non-overlapping. As described below, with reference to FIG. 4A, the first bit range (e.g., a range from the 25th bit position to the 31st bit position from the least significant bit (LSB)) may be a higher bit range than the second bit range (e.g., a range from the 0th bit position to the 24th bit position from the LSB). The command queue 130 may determine a value (e.g., a loop count indicating the number of repetitions of an operation according to a command) from the first bit range (e.g., a 7-bit value from the 25th bit position to the 31st bit position) of an instruction corresponding to the accelerator 140. Additionally, the command queue 130 may determine a command (e.g., an operation to be performed on the accelerator) from the second bit range (e.g., a 25-bit value from the 0th bit position to the 24th bit position) that is different from the first bit range. In other words, an instruction, as an accelerator dedicated instruction structure, may include a value expressed in the first bit range and a command expressed in the second bit range. The value expressed in the first bit range of the instruction may be a setting value for an operation in which an instruction is executed on the accelerator 140 and may be, for example, a loop number or a load length. The command expressed in the second bit range of the instruction may be information indicating the execution of a specific operation in the accelerator 140 and may include an operation identifier (e.g., OP code) indicating the type of operation and various values to be used in an operation. For example, a command may include a value indicating whether an operation to be performed on the accelerator 140 is a tensor operation, a vector operation, or a vector load.

The command queue 130 may provide received commands to an arithmetic logic unit (ALU). The command queue 130 may merge the received instructions through the ALU. For example, the command queue 130 may merge values of instructions having the same command among the received instructions. The result of merging values may be a sum of the values. The command queue 130 may map the sum of the values to a corresponding command. An example of a method by which the command queue 130 merges instructions is described below in detail with reference to FIGS. 4A and 4B. The command queue 130 may provide the merged instruction to the accelerator 140. In an example, the command queue 130 may include an internal memory (e.g., a buffer) configured to receive and store the instructions corresponding to the accelerator 140, a processor (e.g., a different processor than the processor 120) configured to determine the value from the first bit range and determine the command from the second bit range, and the ALU configured to merge the received instructions. In an example, the processor included in the command queue 130 may include the ALU.

As described above, the accelerator 140 may perform one or more of operations allocated to the accelerator among the operations corresponding to the AI model. For example, an operation corresponding to the merged instruction may include at least one of a matrix multiplication operation, a MAC operation, a vector operation, and/or a convolution operation. For example, the accelerator 140 may perform an operation between the input data (e.g., an input vector) loaded from the memory 110 and data (e.g., a weight matrix) pre-stored in the accelerator 140. For example, the accelerator 140 may load the input data from the memory 110 without intervention of the processor 120 based on direct memory access (DMA). The accelerator 140 may pre-store data in an internal memory included in the accelerator 140. The accelerator 140 may perform a tensor operation based on the data pre-stored in the internal memory and the input data received from the memory 110. For example, when the accelerator 140 performs a multiplication operation (e.g., A×B) between a tensor A and a tensor B, the accelerator 140 may receive the tensor A from the memory 110. Additionally, the tensor B may be pre-stored in the accelerator 140. The accelerator 140 may perform the multiplication operation between the tensor A and the tensor B based on a received instruction.

For reference, in order for the computing device 100 to perform operations corresponding to the AI model in parallel based on the processor 120 and the accelerator 140, an accelerator dedicated instruction may used. However, when a typical computing device 100 that does not include the command queue 130 stores all of the dedicated instructions corresponding to the accelerator 140 among the instructions indicating operations based on the AI model described above in the memory 110, the capacity of the memory 110 may be insufficient. In contrast, the command queue 130 of one or more embodiments may merge and store the plurality of instructions corresponding to the accelerator 140, thereby reducing the number of instructions stored in the memory 110, thereby securing the capacity of the memory 110. For example, the command queue 130 may merge instructions indicating iterations (e.g., a loop operation) of the same type of operations.

The accelerator 140 may receive a merged instruction from the command queue 130. In response to receiving the merged instruction from the command queue 130, the accelerator 140 may perform an operation (e.g., an operation between input data and a pre-stored data) corresponding to the merged instruction. As described above, the merged instruction may be generated by merging instructions indicating an operation allocated to the accelerator among the operations based on the AI model.

For example, the accelerator 140 may include an in-memory computing (IMC) circuit. For example, the accelerator 140 may include an IMC circuit configured based on static random access memory (SRAM). The accelerator 140 may perform a digital-based MAC operation. However, this is only an example of the accelerator 140, and the type of the accelerator 140 is not limited thereto.

Accordingly, the computing device 100 may perform an operation corresponding to the AI model based on the processor 120 and the accelerator 140.

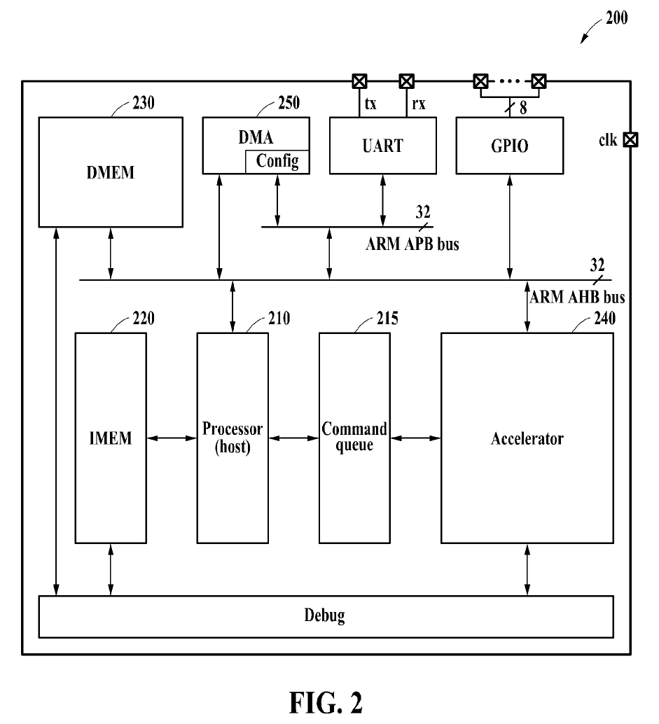

FIG. 2 illustrates an example of a system on chip (SoC) structure including a computing device.

An SoC 200 may include a processor 210 (e.g., the processor 120 of FIG. 1), a command queue 215 (e.g., the command queue 130 of FIG. 1), and an accelerator 240 (e.g., the accelerator 140 of FIG. 1). In an example, the SoC 200 may be or include a computing device (e.g., the computing device 100 of FIG. 1). As described with reference to FIG. 1, the SoC 200 including a computing device may perform operations corresponding to an AI model (e.g., a MAC operation and various operations).

In the SoC 200, the processor 210 (e.g., a CPU) may directly process the operations corresponding to the AI model. Additionally, the processor 210 may cooperate with the command queue 215 and the accelerator 240 to process the operations described above. Accordingly, the SoC structure for AI operations may include the processor 210, memories (e.g., an instruction memory (IMEM) 220, a data memory (DMEM) 230, and the memory 110 of FIG. 1) for the processor 210 and the accelerator 240, and the accelerator 240.

The processor 210, the memories 220 and 230, and the accelerator 240 may be connected to one another via a bus. The processor 210 may transmit and/or receive data to and from the memories 220 and 230 via the bus. The accelerator 240 may transmit and/or receive data to and from the memories 220 and 230 via the bus. The processor 210 may perform a predetermined operation corresponding to the AI model per instruction or control the accelerator 240.

The IMEM 220 may store instructions. The processor 210 and the accelerator 240 may perform an operation corresponding to the AI model in response to receiving instructions stored in the IMEM 220. The IMEM 220 may include a separate memory space for the accelerator 240. When a typical SoC that does not include the command queue 215 stores all instructions corresponding to the accelerator 240 are stored in the IMEM 220, there may be insufficient space in the IMEM 220 to store all instructions corresponding to the AI model. In addition, when the processor 210 accesses the IMEM 220 and transmits, to the accelerator 240, an instruction corresponding to the accelerator 240 every time the processor 210 operates the accelerator 240, the overall operation speed and operation efficiency corresponding to the AI model may decrease. The processor 210 may need to transmit an instruction to the accelerator 210 without accessing a register (e.g., the IMEM 220) in which instructions executed by the accelerator 240 are stored. Accordingly, the SoC 200 of one or more embodiments may include the command queue 215 to dynamically regenerate instructions in response to the accelerator 240, thereby increasing the overall operation speed and operation efficiency corresponding to the AI model. An example of the operation of the command queue 215 is described in detail below with reference to FIGS. 4A and 4B. The DMEM 230 may store data generated through operations by the processor 210 and the accelerator 240.

The processor 210 may perform an operation corresponding to a corresponding instruction in response to receiving an instruction from the IMEM 220. The processor 210 may generate a control signal during the process of executing an instruction and transmit the control signal to the accelerator 240. The processor 210 may write the generated control signal and/or a result of performing an operation to the DMEM 230.

The movement of data input/output to/from the accelerator 240 may be performed through DMA 250. The processor 210 may generate a control signal for the DMA 250 and the accelerator 240. Accordingly, the accelerator 240 may load data from a memory without intervention or with reduced intervention of the processor 210 based on the DMA 250.

For reference, when the ratio of MAC operations among the operations corresponding to the AI model is lower than the ratio of non-MAC operations, the time and energy required for the typical SoC that does not include the command queue 215 to control the accelerator 240 may be greater than the time and energy required to process the operations corresponding to the AI model. Additionally, to use the accelerator 240, dedicated instructions for the accelerator 240 may be required in the typical SoC. In particular, when repetitive operations occur frequently within a plurality of layers, such as in the AI model, the number of instructions may unnecessarily increase in order to perform the repetitive operations through the accelerator 240. Therefore, the SoC 200 of one or more embodiments may dynamically regenerate instructions corresponding to the repetitive operations based on the command queue 215. For example, the command queue 215 may regenerate an instruction dedicated to the accelerator 240 by dynamically merging the instructions corresponding to the repetitive operations. An example of the method of dynamically merging instructions based on the command queue 215 is described in detail below with reference to FIGS. 4A and 4B.

Therefore, the SoC 200 of one or more embodiments may secure a space to store instructions by merging instructions repeatedly performed in the accelerator 240 by using the command queue 215 that generates the instructions for the operations repeatedly performed in the accelerator 240.

FIG. 3 illustrates an example of a method of performing an operation corresponding to an AI model in a computing device.

A computing device 300 (e.g., the computing device 100 of FIG. 1) may perform an operation corresponding to an AI model based on a memory 310 (e.g., the memory 110 of FIG. 1), a processor 320 (e.g., the processor 120 of FIG. 1), a command queue 380 (e.g., the command queue 130 of FIG. 1), and an accelerator 390 (e.g., the accelerator 140 of FIG. 1).

In operation 330, the processor 320 may fetch a plurality of instructions from the memory 310. For example, the processor 320 may receive the plurality of instructions from the memory 310 via a bus (e.g., the bus of FIG. 2). The plurality of instructions may include instructions indicating the execution of an operation corresponding to the AI model. The plurality of instructions may have bit value(s) of a predetermined length and may be expressed in a 32-bit length, for example, when the processor 320 corresponds to a RISC-V CPU.

In operation 340, the processor 320 may decode the received instructions. For example, the processor 320 may classify instructions of a predetermined length (e.g., instructions of 32-bit size) among the received plurality of instructions. The processor 320 may identify an operation identifier (e.g., an OP code) corresponding to a specific bit range of the classified instructions of the predetermined length. The processor 320 may distinguish, based on the operation identifier, whether the instruction of the predetermined length is an instruction corresponding to the processor 320 or an instruction corresponding to the accelerator 390. In the process of executing an AI operation, the processor 320 may transmit, to the command queue 380, instructions corresponding to the accelerator 390 among the instructions of the predetermined length. In this case, the instructions transmitted from the processor 320 to the command queue 380 may represent instructions specialized for the accelerator 390. The processor 320 may transmit the instructions corresponding to the accelerator 390 to the command queue 380 until the queue (e.g., a buffer) of the command queue 380 is full. The command queue 380 may generate a stall signal to stop transmission of the instructions corresponding to the accelerator 390 when the queue is full. The command queue 380 may transmit the generated stall signal to the processor 320. An example of the specified bit range of the instructions of the predetermined length is described in detail below with reference to FIG. 4A. The processor 320 may decouple the instructions corresponding to the accelerator 390 among the plurality of instructions (e.g., instructions for operating the accelerator 390) from an operation pipeline of the processor 320.

In operation 350, the processor 320 may execute an AI operation corresponding to the plurality of instructions. For example, the computing device 300 may include the processor 320 and a plurality of accelerators (e.g., a plurality of accelerators including the accelerator 390). When the computing device 300 includes the plurality of accelerators, each of the plurality of accelerators may be connected to the processor 320 and the command queue 380. For example, the processor 320 may be connected to the command queue 380, and the command queue 380 may be connected to first to N-th accelerators. N may be a natural number greater than or equal to 2. The processor 320 may determine the accelerator 390 to which an instruction is transmitted from the command queue 380 among the first to N-th accelerators. In other words, the processor 320 may transmit an instruction to each accelerator from the command queue 380 by considering the operation order of the first to N-th accelerators. The computing device 300 may perform an operation corresponding to the AI model based on the processor 320 and the accelerator 390. In this process, the processor 320 may store a stall signal generated in an instruction pipeline of the processor 320 in a score board. For example, the stall signal may be caused by data dependency or hardware resource shortages. For example, the stall signal may be a signal generated when an accelerator required to execute an instruction is already in use by another instruction. For example, the stall signal may be a signal generated when the execution order of instructions overlaps or conflicts. For example, the processor 320 may receive the stall signal from the command queue 380 when the queue of a corresponding command queue is full. The processor 320 may store the received stall signal in the score board. The processor 320 may stall the operation pipeline of the processor 320 based on the stall signal stored in the score board.

The command queue 380 may dynamically classify the instructions corresponding to the accelerator 390 received from the processor 320. For example, the command queue 380 may determine a value from a first bit range of the instructions corresponding to the accelerator 390. For example, the command queue 380 may determine a command from a second bit range that is different from the first bit range of the instructions corresponding to the accelerator 390. The command queue 380 may classify the instructions based on a command representing a bit value expressed in the second bit range. For example, the command queue 380 may determine, as instructions to be merged, instructions having the same command value (e.g., bit values of the second bit range) in the second bit range. An example of a method by which the command queue 380 merges instructions is described in detail below with reference to FIGS. 4A and 4B. The command queue 380 may transmit merged instructions to the accelerator 390. The accelerator 390 may perform an operation corresponding to the AI model based on the merged instructions transmitted from the command queue 380.

In operation 360, the processor 320 may perform a memory write back operation to store an AI operation result executed based on an instruction corresponding to the processor 320 in the memory 310. Additionally, the processor 320 may store the AI operation result in a register file 370. The processor 320 may store the AI operation result in the memory 310 and the register file 370 so that the AI operation result may be used in a subsequent AI operation.

FIGS. 4A and 4B illustrate examples of a method of merging instructions performed by a command queue.

Referring to FIG. 4A, a processor (e.g., the processors 120, 210, and/or 320 of FIGS. 1 to 3) may enqueue an instruction 401 corresponding to an accelerator to a command queue (e.g., the command queues 130, 215, and/or 380 of FIGS. 1 to 3). The instruction 401 may include an instruction of a predetermined length.

The processor may classify instructions of a predetermined length as instructions corresponding to the accelerator or instructions corresponding to the processor based on an operation identifier (e.g., Opcode of FIG. 4) corresponding to a specific bit range 410 of the instructions of the predetermined length. The specific bit range may be included in a second bit range 430. For example, when a predetermined instruction has a length of 32 bits, the second bit range 430 may be a range from the 0th bit position to the 24th bit position from the LSB, and the specific bit range 410 may be a range from the 0th bit position to the 6th bit position from the LSB. Based on values of the bit range 410 specified in instructions, the processor may classify the instructions as either instructions corresponding to the accelerator or instructions corresponding to the processor.

The processor may transmit the instruction 401 corresponding to the accelerator among the classified instructions to the command queue.

The command queue may determine a value from a first bit range 420 of the instruction 401 corresponding to the accelerator. The command queue may determine a command from the second bit range 430 of the instruction 401 corresponding to the accelerator. For example, the command queue may determine, as a value of an instruction, a bit value of the first bit range 420 corresponding to the 31st bit position to the 25th bit position. For example, the command queue may determine, as the command, a bit value in the second bit range 430 including the 24th bit position to the 0th bit position.

The command queue may scan the instruction 401 through a window 450 of a predetermined size. For example, the command queue may arrange a plurality of instructions including the instruction 401 input to the command queue in the order the instructions are input. The command queue may scan the plurality of instructions arranged in the order the instructions are input through the window 450 of the predetermined size. Referring to FIG. 4A, the command queue may scan, based on the window 450, the plurality of instructions sequentially input, three at a time.

The command queue may compare the instructions (e.g., three commands) scanned through the window 450 of the predetermined size. For example, the command queue may determine whether commands (e.g., CMD of FIG. 4A) of the scanned instructions based on the window 450 are identical to each other.

The command queue may provide the scanned instructions to an ALU 470 based on the comparison results between the scanned instructions. When the instructions included in the window 450 have the same command, the command queue may input the instructions included in the window 450 to the ALU 470. For example, when a command of a first instruction is the same as a command of a second instruction among the scanned instructions, the command queue may input a value (e.g., V of FIG. 4A) of the first instruction and a value of the second instruction to the ALU 470. The command queue may provide the scanned instructions to the ALU 470 to merge the instructions including the same command. For example, the command queue may sum the value of the first instruction and the value of the second instruction by inputting the value of the first instruction and the value of the second instruction to the ALU 470. The command queue may map the value of the first instruction and the value of the second instruction to the commands of the scanned instructions. Accordingly, the command queue may generate a merge instruction 480 having a sum of values (e.g., V’ of FIG. 4A) for a corresponding command. For example, when it is assumed that the same operation is performed repeatedly on the accelerator, a value of an instruction may indicate a loop count, and a command may indicate the type of an instruction to be performed on the accelerator. The command queue may generate the merged instruction 480 by merging instructions having the same command. Thus, a computing device of one or more embodiments may overcome the disadvantage of a typical computing device where the number of pieces of information that may be included in instructions of a predetermined length is limited. The command queue of one or more embodiments may improve memory efficiency of the command queue by merging instructions having the same command. The command queue may transmit the merged instruction 480 to the accelerator by dequeuing the merged instruction 480.

Referring to FIG. 4B, the command queue may merge loop counts as values of instructions including the same command.

In operation 490, a processor 481 (e.g., the processors 120, 210, and/or 320 of FIGS. 1 to 3) may enqueue four instructions 495 corresponding to the accelerator to the command queue. In this case, the instructions 495 may include a value indicating a loop count in the first bit range and a command indicating a tensor operation (e.g., HW_TENSOR_COMPUTE) in the second bit range. In other words, the instructions 495 may include a value indicating the number of times the accelerator repeats the same command and an operation corresponding to the command. However, when the processor corresponds to a RISC-V CPU, the size of an instruction received from the processor may be fixed to 32 bits. As described with reference to FIG. 4A, when an instruction is 32 bits in size, the command queue may determine, as the value of the instruction, the value within the first bit range 420 corresponding to the 31st bit position to the 25th bit position. Therefore, the loop count, which indicates the number of times a command is repeated, may be limited to a maximum of 2⁷ (i.e., 128). In other words, even when an instruction including the command is repeatedly executed more than 128 times by the accelerator, the size of the instruction is fixed to 32 bits, so a typical computing device may have to unnecessarily input the same instruction to the accelerator. When the processor of the typical computing device sequentially inputs the instructions 495 to the accelerator, even though the instructions 495 cause the same operation of the accelerator, each instruction may occupy memory, thereby reducing memory efficiency and operating efficiency of the accelerator. Accordingly, the command queue of one or more embodiments may generate a merged instruction 499 obtained by merging values of the instructions 495 for the same command (e.g., HW_TENSOR_COMPUTE) of the enqueued instructions 495. For example, the command queue may generate the merged instruction 499, which is a single extended merged instruction indicating a cumulative number of iterations of 448 by merging the separate instructions 495, which execute the same command (e.g., HW_TENSOR_COMPUTE) 128, 128, 128, and 64 times, respectively, thereby improving memory efficiency and operating efficiency of the accelerator.

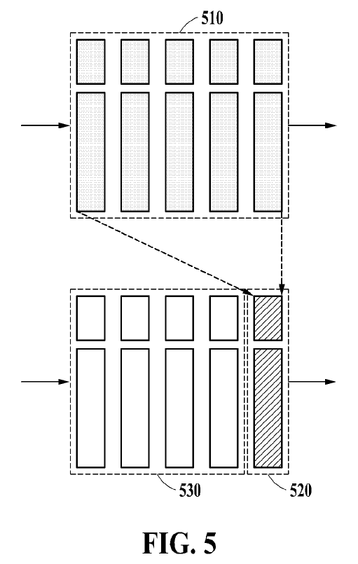

FIG. 5 illustrates an example of a reduction in an operation delay time of a processor when a command queue generates a merged instruction.

A command queue (e.g., the command queues 130, 215, and/or 380 of FIGS. 1 to 3) may receive instructions 510 corresponding to an accelerator of a predetermined length from a processor. For example, the command queue may receive 32-bit instructions 510 from the processor.

The command queue may generate a stall signal to stop the transmission of the instructions 510 from the processor to the command queue when a queue of the command queue is full. For example, as illustrated in FIG. 5, it is assumed that the command queue may enqueue up to five instructions 510 from the processor. Referring to FIG. 5, the command queue may generate the stall signal that stops the transmission of instructions from the processor to the command queue because the queue is full of the five instructions 510. The command queue may transmit the generated stall signal to the processor.

In this case, the command queue may determine values and commands respectively corresponding to the five instructions 510. The command queue may compare the commands of the five instructions 510 to determine whether the five instructions 510 have the same command. When the five instructions 510 each have the same command, the command queue may determine the five instructions as target instructions to be merged. When the five instructions 510 each have the same command, the command queue may merge all values of the five instructions 510. The command queue may map the result of merging the values of the five instructions 510 to a command corresponding to the five instructions 510. The command queue may generate a merged instruction 520 obtained by mapping the merged values to the command.

When Z generates one merged instruction 520, the command queue may include four empty states 530. Free memory corresponding to the empty states 530 may be secured (e.g., obtained or generated). When the command queue includes the empty states 530, the command queue is not full of instructions, and therefore, a stall signal that stops the transmission of instructions from the processor to the command queue may not be generated. The command queue of one or more embodiments may reduce the frequency of stall signal occurrence due to the limited queue of the command queue. In other words, the command queue of one or more embodiments may secure more memory space (e.g., the empty states 530) for instructions, and may thus alleviate delay in an AI operation.

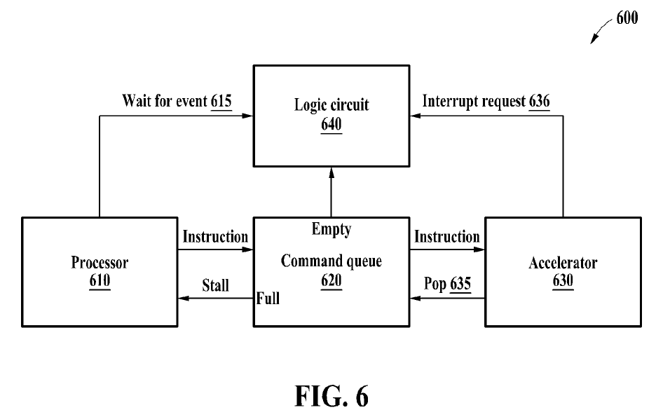

FIG. 6 illustrates an example of an AI operation based on a computing device.

A computing device 600 (e.g., the computing devices 100 and/or 300of FIGS. 1 and 3) may include a processor 610 (e.g., the processors 120, 210, 320, and/or 481 of FIGS. 1 to 3 and 4B), a command queue 620 (e.g., the command queues 130, 215, and/or 380 of FIGS. 1 to 3), an accelerator 630 (e.g., the accelerators 140 and/or 390 of FIGS. 1 and 3), and a logic circuit 640. Referring to FIG. 6, the logic circuit 640 is illustrated as a hardware component, but functions performed by the logic circuit 640 may be implemented in software.

The processor 610 may transmit instructions of a predetermined length corresponding to the accelerator 630 to the command queue 620.

The command queue 620 may sequentially arrange the instructions received from the processor 610. For example, the command queue 620 may process the received instructions on a first-in first-out (FIFO) basis. The command queue 620 may merge the sequentially received instructions. An example of a method by which the command queue 620 merges instructions is described above with reference to FIGS. 4A and 4B, and thus any repeated description thereof is omitted. The command queue 620 may transmit a stall signal to the processor 610 when a queue (enqueue) is full. The command queue 620 may transmit merged instructions to the accelerator 630.

The accelerator 630 may perform an AI operation based on the transmitted instructions. The accelerator 630 may perform an operation between input data and pre-stored data based on merged instructions transmitted from the command queue 620 on a FIFO basis. In response to terminating the operation between the input data and the pre-stored data, the accelerator 630 may transmit a request signal 635 (e.g., "pop" in FIG. 6) requesting the command queue 620 to provide another merged instruction.

While the AI operation is performed in the accelerator 630, the processor 610 may transmit a first signal 615 (e.g., "wait for event" in FIG. 6) to the logic circuit 640. In other words, the processor 610 may transmit, to the logic circuit 640, the first signal 615 indicating that the AI operation is in a waiting state while the accelerator 630 is operating. When terminating the execution of the AI operation based on the merged instructions transmitted from the command queue 620, the accelerator 630 may transmit a second signal 636 (e.g., “interrupt request” in FIG. 6) to the logic circuit 640. The logic circuit 640 may receive, from the command queue 620, a signal indicating that a current queue of the command queue 620 is in an empty state and may resume the operation of the processor 610 when receiving the second signal 636 from the accelerator 630. The processor 610 may transmit new instructions to the command queue 620 when the operation of the processor 610 resumes.

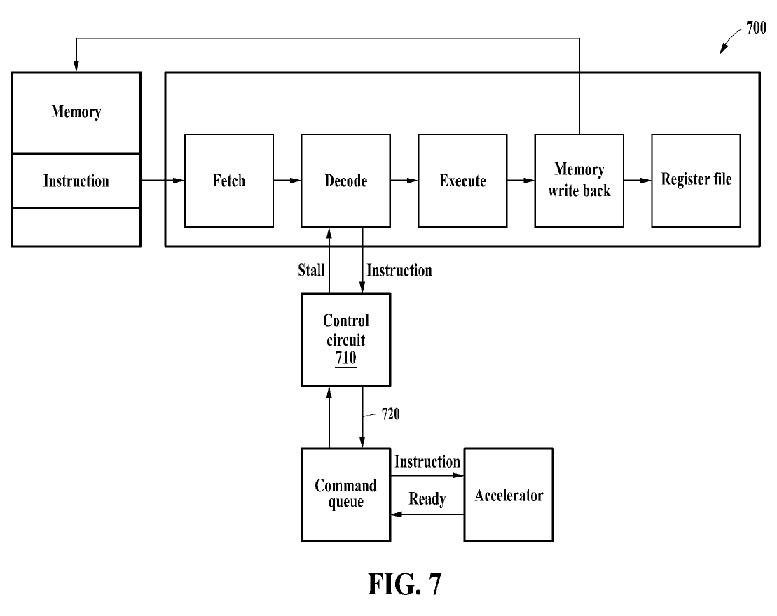

FIG. 7 illustrates an example of a method of performing an operation corresponding to an AI model in a computing device.

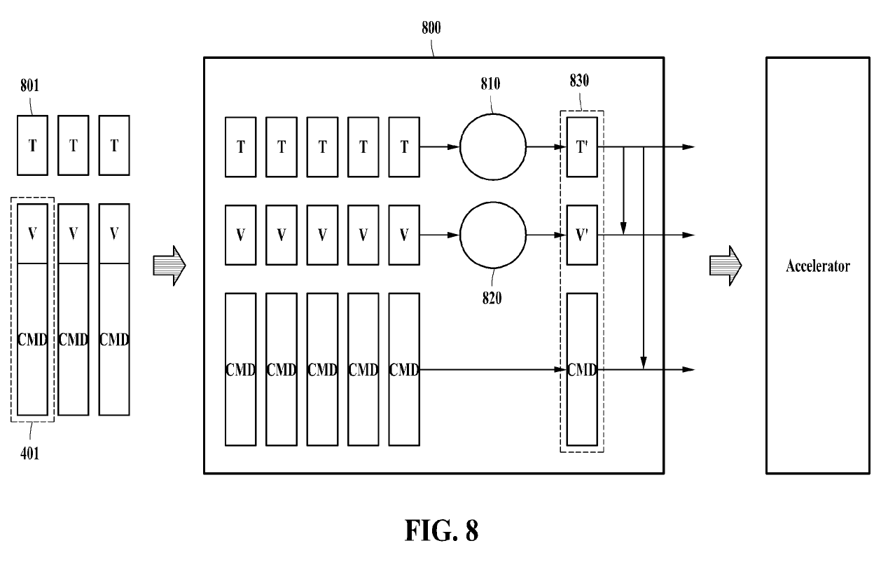

A computing device 700 may perform an operation corresponding to an AI model. The computing device 700 may include a memory, a processor, a command queue, and an accelerator as shown in FIG. 3. However, as illustrated in FIG. 7, the computing device 700 may further include a control circuit 710 unlike the computing device 300 of FIG. 3. The control circuit 710 may be referred to as a command history table, but examples are not limited thereto. The control circuit 710 may compare instructions corresponding to the accelerator transmitted from the processor to the command queue. For example, the control circuit 710 may compare a current instruction, a previous instruction, and a newly incoming instruction with one another based on instructions sequentially received from the processor. The control circuit 710 may generate a control signal 720 to determine whether to transmit a merged instruction from the command queue to the accelerator based on a comparison result between the received instructions. The command queue may determine whether to merge and/or dequeue the instructions received from the processor based on the control signal 720 received from the control circuit 710. An example of the operation of merging the instructions performed in the command queue based on the control signal 720 generated from the control circuit 710 is described in detail below with reference to FIG. 8.

FIG. 8 illustrates an example of a method of merging instructions performed by a command queue.

A command queue 800 (e.g., the command queues 130, 215, and/or 380 of FIGS. 1 to 3) may receive, from a processor, the instruction 401 corresponding to an accelerator. The command queue 800 may determine a first bit range of the instruction 401 received from the processor as a value and a second bit range as a command. An example of a method by which the command queue 800 determines a value and a command according to a bit range of the instruction 401 is described with reference to FIG. 4A, and thus any repeated description thereof is omitted. The command queue 800 may receive a control signal 801 from a control circuit (e.g., the control circuit 710 of FIG. 7). For example, the command queue 800 may receive a 1-bit control signal 801 generated by the control circuit.

The control circuit may generate a first control signal when a current instruction and a previous instruction among instructions (e.g., instructions including the instruction 401) corresponding to the accelerator transmitted from the processor to the command queue 800 have the same command. For example, the control circuit may generate the first control signal corresponding to a value of 0 when the current instruction and the previous instruction received by the command queue 800 have the same command. The first control signal may be referred to as a first trigger bit corresponding to a value of 0, but examples are not limited thereto. The control circuit may generate a second control signal that is different from the first control signal when the command included in the current instruction is different from the command included in the previous instruction. The second control signal may be referred to as a second trigger bit corresponding to a value of 1, but examples are not limited thereto. The computing device may enqueue the instruction 401 received from the processor and the control signal 801 received from the control circuit together to the command queue 800.

The command queue 800 may sequentially input the control signal 801 to the logic circuit 810. In this case, when receiving the first control signal, the command queue 800 may merge instructions corresponding to the accelerator received from the processor based on inputting the first control signal to the logic circuit 810. For example, the command queue 800 may receive the first control signal corresponding to a value of 0. The command queue 800 may generate a merged instruction 830 based on inputting the received first control signal to the logic circuit 810 and inputting the current instruction and the previous instruction to an ALU 820. When receiving a second signal, the command queue 800 may dequeue the merged instruction 830 to the accelerator. In other words, the processor may sequentially input instructions corresponding to the accelerator to the command queue 800. In this case, the processor may input instructions to the command queue 800 and when the input instructions are the same as a previous instruction, input the first control signal transmitted from the control circuit to the command queue 800. When the instructions input to the command queue 800 are not the same as the previous instruction, the processor may input, to the command queue 800, the second control signal transmitted from the control circuit. When the command of the current instruction input to the command queue 800 is the same as the command of the previous instruction, the command queue 800 may receive the first control signal (e.g., a bit value of 0). Accordingly, when receiving the first control signal, the command queue 800 may accumulate and merge the current instruction and the previous instruction corresponding to the first control signal. When a command included in an instruction received at a predetermined point in time is different from a command included in an instruction received immediately before the predetermined point in time among instructions transmitted to the command queue 800, the command queue 800 may receive the second control signal. When receiving the second control signal, the command queue 800 may dequeue the merged instruction 830 obtained by accumulating and merging instructions up to the predetermined point in time to the accelerator. The command queue 800 of of one or more embodiments may flexibly adjust the number of merged instructions by merging more repeated instructions than instructions included in a window size limitedly through a window of a predetermined size.

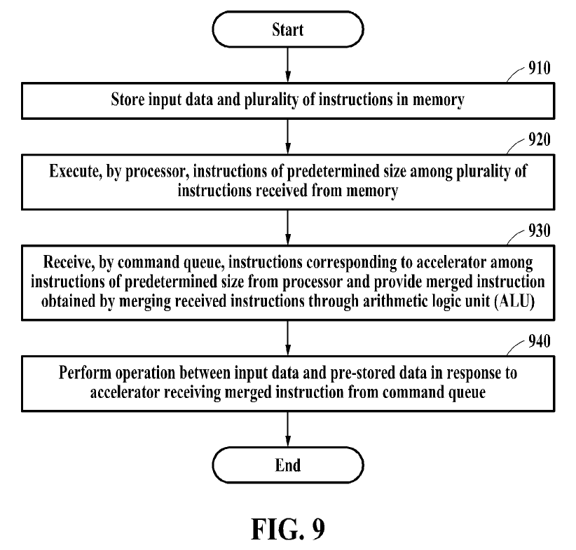

FIG. 9 illustrates an example of an operation of a computing device. Operations 910 to 940 of FIG. 9 may be performed in the sequence and manner as illustrated in FIG. 9. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 910, a computing device (e.g., the computing devices 100, 300, and 600 of FIGS. 1, 3, and 6) may store input data and a plurality of instructions in a memory.

In operation 920, the computing device may execute instructions of a predetermined length among the plurality of instructions received from the memory to a processor. The computing device may include the processor that executes an operation based on the instructions of the predetermined length. For example, the processor may include a RISC-V CPU. The computing device may transmit an instruction corresponding to the accelerator to a command queue decoupled from the processor while executing the instructions of the predetermined length. In other words, the computing device may be distinct from a pipeline for performing an operation of the processor and may perform an AI operation through a separate pipeline implemented through the command queue.

In operation 930, the computing device may merge the instructions received by the command queue and provide the merged instruction to the accelerator. For example, the command queue included in the computing device may receive, from the processor, instructions corresponding to the accelerator among the instructions of the predetermined length. The command queue may provide the merged instruction obtained by merging the received instructions through an ALU.

In operation 940, the accelerator included in the computing device may perform an operation between input data and pre-stored data in response to receiving the merged instruction from the command queue.

The operations of the computing device performed in operations 910 to 940 are described with reference to FIGS. 1 to 8, and thus any repeated description thereof is omitted.

The computing devices, memories, processors, command queues, accelerators, SoCs, IMEMs, DMEMs, DMAs, ALUs, logic circuits, control circuits, computing device 100, memory 110, processor 120, command queue 130, accelerator 140, SoC 200, processor 210, command queue 215, IMEM 220, DMEM 230, accelerator 240, DMA 250, computing device 300, memory 310, processor 320, command queue 380, accelerator 390, ALU 470, processor 481, computing device 600, processor 610, command queue 620, accelerator 630, logic circuit 640, computing device 700, control circuit 710, and command queue 800 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks , and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A computing device comprising:
a memory configured to store input data and a plurality of instructions;
a processor configured to execute instructions of a predetermined length among the plurality of instructions received from the memory;
a command queue configured to receive, from the processor, instructions corresponding to an accelerator among the instructions of the predetermined length and generate a merged instruction by merging the received instructions through an arithmetic logic unit (ALU); and
the accelerator configured to perform an operation between the input data and pre-stored data in response to receiving the merged instruction from the command queue.

2. The computing device of claim 1, wherein, for the executing of the instructions of the predetermined length, the processor is configured to:
based on an operation identifier corresponding to a specific bit range of the instructions of the predetermined length, classify the instructions of the predetermined length as instructions corresponding to the accelerator or instructions corresponding to the processor; and
transmit the instructions classified as the instructions corresponding to the accelerator to the command queue.

3. The computing device of claim 1, wherein, for the generating of the merged instruction, the command queue is configured to determine a value from a first bit range of instructions corresponding to the accelerator and determine a command from a second bit range that is different from the first bit range.

4. The computing device of claim 1, wherein, for the generating of the merged instruction, the command queue is configured to scan the received instructions corresponding to the accelerator through a window of a predetermined size and merge, based on a comparison result between the scanned instructions, the scanned instructions based on the ALU.

5. The computing device of claim 4, wherein, for the merging of the scanned instructions, the command queue is configured to:
determine, for each of the scanned instructions, a value from a first bit range of the scanned instruction and determine a command from a second bit range of the scanned instruction that is different from the first bit range; and
merge, based on the ALU, the value of a first instruction of the scanned instructions with the value of a second instruction of the scanned instructions in response to the command of the first instruction being same as the command of the second instruction among the scanned instructions.

6. The computing device of claim 5, wherein
for each of the scanned instructions, the value of the scanned instruction indicates a number of repetitions of an operation according to the command of the scanned instruction, and
for the merging of the value of the first instruction with the value of the second instruction, the command queue is configured to accumulate the value of the first instruction and the value of the second instruction using the ALU.

7. The computing device of claim 1, wherein, for the generating of the merged instruction, the command queue is configured to:
in response to a queue of the command queue being full, generate a stall signal that stops transmission of the instructions corresponding to the accelerator from the processor to the command queue; and
transmit the generated stall signal to the processor.

8. The computing device of claim 1, further comprising a control circuit configured to, based on a comparison result between the instructions corresponding to the accelerator transmitted from the processor to the command queue, determine whether to transmit the merged instruction to the accelerator.

9. The computing device of claim 8, wherein, for the determining of whether to transmit the merged instruction, the control circuit is configured to:
generate a first control signal in response to a command comprised in a current instruction being same as a command comprised in a previous instruction of the current instruction among the instructions corresponding to the accelerator transmitted from the processor to the command queue; and
generate a second control signal that is different from the first control signal in response to the command comprised in the current instruction being different from the command comprised in the previous instruction.

10. The computing device of claim 9, wherein the command queue is configured to:
merge the instructions corresponding to the accelerator received from the processor in response to receiving the first control signal from the control circuit; and
transmit the merged instruction to the accelerator in response to receiving the second control signal from the control circuit.

11. The computing device of claim 1, wherein the accelerator is configured to transmit a request signal that requests the command queue to provide another merged instruction in response to terminating the operation between the input data and the pre-stored data.

12. A computing method comprising:
storing input data and a plurality of instructions in a memory;
executing, by a processor, instructions of a predetermined length among the plurality of instructions received from the memory;
receiving, by a command queue, instructions corresponding to an accelerator among the instructions of the predetermined length from the processor and generating a merged instruction by merging the received instructions through an arithmetic logic unit (ALU); and
performing an operation between the input data and pre-stored data in response to the accelerator receiving the merged instruction from the command queue.

13. The method of claim 12, wherein the executing of the instructions of the predetermined length comprises:
based on an operation identifier corresponding to a specific bit range of the instructions of the predetermined length, classifying, by the processor, the instructions of the predetermined length as instructions corresponding to the accelerator or instructions corresponding to the processor; and
transmitting the instructions classified as the instructions corresponding to the accelerator to the command queue.

14. The method of claim 12, wherein the generating of the merged instruction comprises determining a value from a first bit range of the instructions corresponding to the accelerator and determining a command from a second bit range that is different from the first bit range.

15. The method of claim 12, wherein the generating of the merged instruction comprises:
scanning the received instructions corresponding to the accelerator through a window of a predetermined size; and
merging, based on a comparison result between the scanned instructions, the scanned instructions based on the ALU.

16. The method of claim 15, wherein the merging of the scanned instructions comprises:
determining, for each of the scanned instructions, a value from a first bit range of the scanned instruction and determining a command from a second bit range of the scanned instruction that is different from the first bit range; and
merging, based on the ALU, the value of a first instruction of the scanned instructions with the value of a second instruction of the scanned instructions in response to the command of the first instruction being the same as the command of the second instruction among the scanned instructions.

17. The method of claim 12, wherein the generating of the merged instruction comprises:
in response to a queue of the command queue being full, generating a stall signal that stops transmission of the instructions corresponding to the accelerator from the processor to the command queue; and
transmitting the generated stall signal to the processor.

18. The method of claim 12, further comprising, based on a comparison result between the instructions corresponding to the accelerator transmitted from the processor to the command queue, determining, by a control circuit, whether to transmit the merged instruction from the command queue to the accelerator.

19. The method of claim 18, wherein the determining of whether to transmit the merged instruction comprises:
generating a first control signal in response to a command comprised in a current instruction being same as a command comprised in a previous instruction of the current instruction among the instructions corresponding to the accelerator transmitted from the processor to the command queue; and
generating a second control signal that is different from the first control signal in response to the command comprised in the current instruction being different from the command comprised in the previous instruction.

20. A computing method comprising:
generating a merged instruction by merging, using an arithmetic logic unit (ALU), a value of a first instruction with a value of a second instruction in response to a command of the first instruction being the same as a command of the second instruction, the first instruction and the second instruction being of instructions corresponding to an accelerator; and
performing, using the accelerator, an operation between input data and pre-stored data based on the merged instruction.
